(19) United States
(12) Patent Application Publication
(10) Pub. No.: US 2026/0185550 A1
(43) Pub. Date: Jul. 2, 2026

(54) SWIRLING FLOW GENERATING DEVICE THAT CAN CHANGE THE ROTATION DIRECTION PERIODICALLY

(71) Applicant: ROKETSAN ROKET SANAYII TICARET A.S., Elmadag/Ankara (TR)

(72) Inventor: Mehmet Nazim TOMAÇ, Elmadag/Ankara (TR)

(21) Appl. No.: 18/868,250

(22) PCT Filed: Jun. 13, 2023
(86) PCT No.: PCT/TR2023/050562

§ 371 Date: Nov. 22, 2024

(30) Foreign Application Priority Data
Jun. 14, 2022 (TR) 2022/009849

(51) Int. Cl. F15D 1/00

(52) U.S. Cl. CPC F15D 1/0015

(57) ABSTRACT

The invention relates to a device that provides a more homogenised flow characteristic in both directions by periodically changing the rotation direction of the swirling flow to be used in rocket injectors, fluid distributing components such as shower heads, and to be used as an aerodynamic flow control actuator.

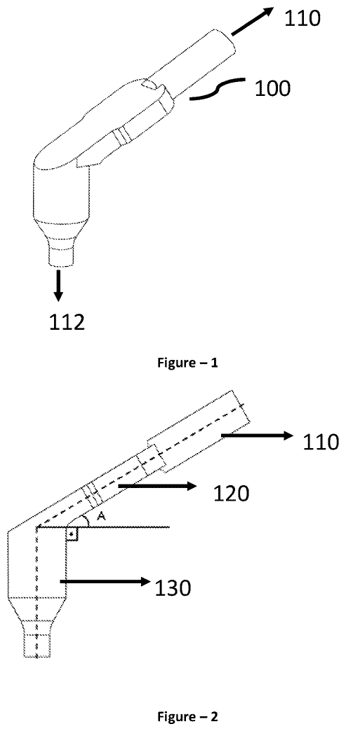

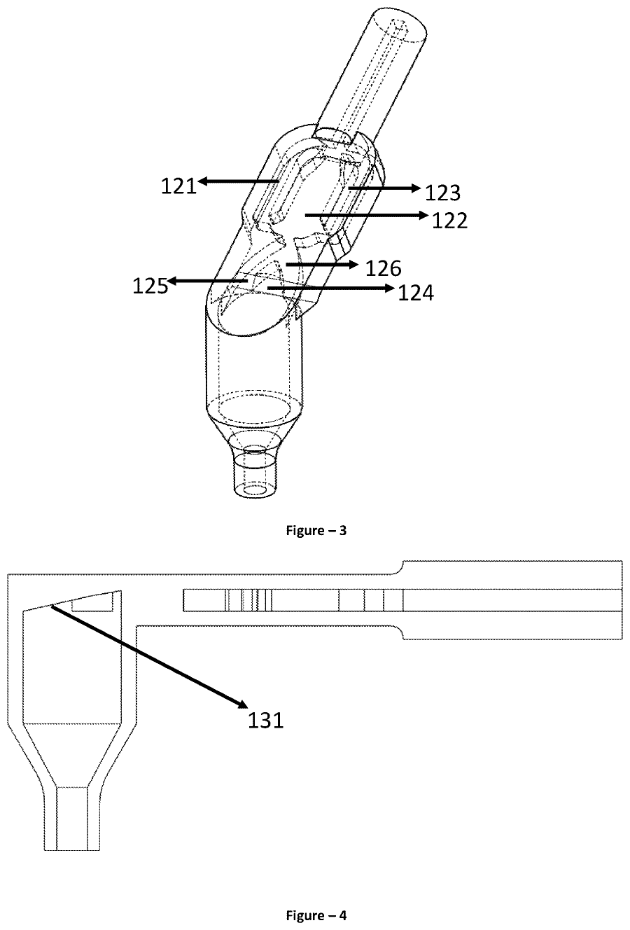

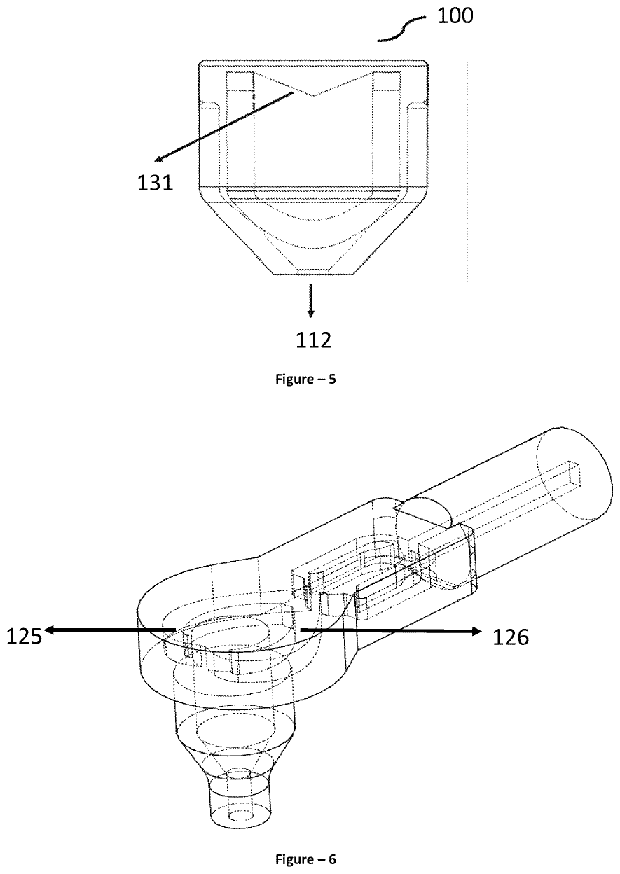

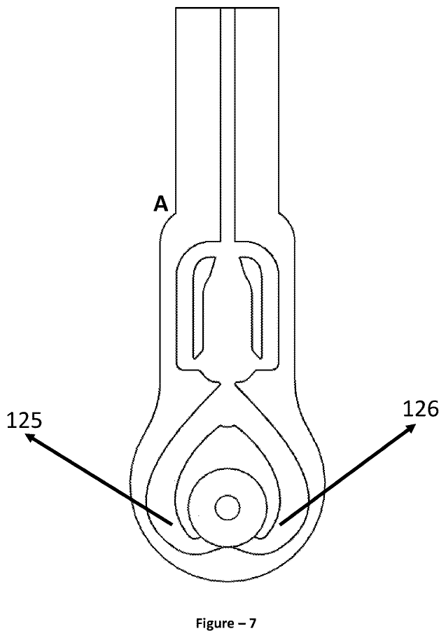

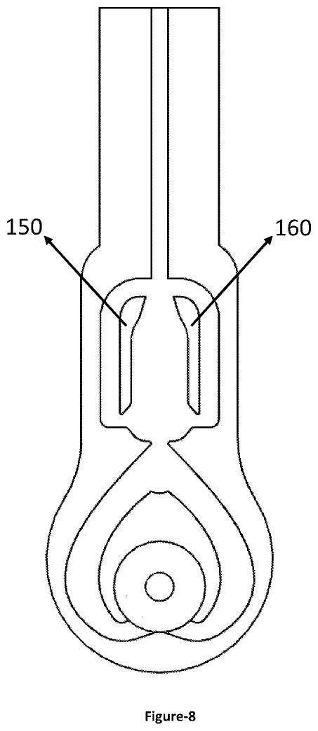

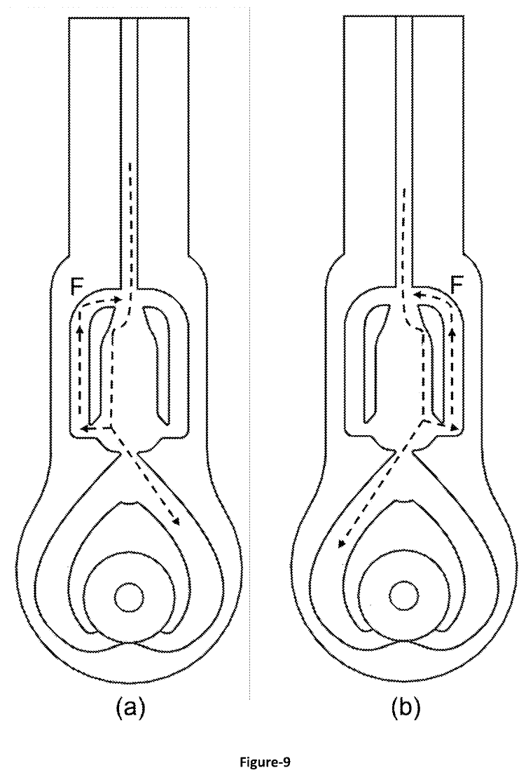

### TECHNICAL FIELD OF THE INVENTION

The invention relates to a no-moving-parts device for periodically changing the flow direction for devices that generate swirl flow.

In particular, the invention relates to a device that provides a more homogenised flow characteristic in both directions by periodically changing the rotation direction of the swirl flow to be used in rocket injectors, fluid distributing components such as shower heads, and to be used as an aerodynamic flow control actuator.

### STATE OF THE ART

The movement of substances with free molecular motion from one point to another point spontaneously or with the effect of a force can be defined as flow. Free molecular motion is also observed in substances defined as fluids in liquid or gaseous form. Flow movements of flows in a closed channel such as a pipe are generally grouped under 3 main headings as laminar flow, transitional flow and turbulent flow, and the flow of a fluid depends on the forces created by inertia, viscosity and pressure differences.

The regular flow of the fluid without any fluctuations throughout the flow area is called laminar flow. Individual fluid particles capable of free molecular motion do not interrupt the trajectories of neighbouring particles during flow, and steady flow of high viscosity fluids at low speeds is an example of laminar flow.

The fluctuating and irregular flow, which is usually seen in high velocity flows of fluids, is called turbulent flow. Individual fluid particles capable of free molecular motion interrupt the orbits of neighbouring particles during flow, causing the molecules to collide and the flow order to be disrupted and agitated. The high velocity flow of fluids such as air is called turbulent flow.

Flow that changes continuously between laminar and turbulent flow is called transitional flow. While transitional flow can be observed depending on the velocity and viscosity of the fluid in closed environments such as pipes, laminar and turbulent flow can be observed in the outlets of closed environments such as pipes or in places where there is natural flow.

The Reynolds number is the number that determines the type of flow of the fluid passing through a particular pipe or geometry. The Reynolds number depends on the density, velocity, and viscosity of the fluid, and the diameter of the flow channel. Reynolds number below 2000 indicates laminar flow, 2000 to 4000 transitional flow, and over 4000 turbulent flow.

In laminar flow, viscosity forces affect molecular motions more than inertial forces. Therefore, the Reynolds number is small. In laminar flow, the effect of inertial forces is greater due to the increase in fluid velocity in turbulent flow, which occurs as a result of instability and agitation that occurs with the increase in velocity. As a result of the relative movement between the moving molecules in the fluid, viscous stresses occur and relative movements that try to remove this stress arise due to the inertial force. Therefore, the Reynolds number is large.

In external flow that is not limited to a certain area, even if the flow is laminar without geometrical factors, a transition to turbulent flow occurs after a certain distance due to the speed and the size of the acting forces. This distance is called the critical distance and the Reynolds number is calculated depending on the velocity, density, dynamic viscosity, and critical distance of the fluid.

Swirling flow occurs when the disorder in turbulent flows rotates in a particular direction. Swirling flows are used in mechanical systems in many areas because they have a certain speed and direction. There are various designs that can create swirling flow in injectors in rocket structures. These designs are produced with the principle of rotationally accelerating the fluid along a cylindrical surface after being sent from a tangential inlet and dispersing the fluid over a wide area in the form of a spray by being swept away by the effect of centrifugal force at the outlet end. The fluid leaving the injector is swept away by the centrifugal effect and first forms a liquid film whose length varies according to certain parameters. As a result of the Kelvin-Helmholtz instability on this film, ruptures occur and the fluid in the liquid phase is atomized. Due to the centrifugal force acting on the fluid at the outlet end, the number of droplets increases, and the fluid can atomize.

Due to the high speed and swirling turbulent flow, the spray takes the form of a cone and a volume filled with air is formed in the middle, and there are two phases of fluid in the environment. The depth of this volume can extend to the end where the fluid enters. The reason for the separation created by this volume is that some of the energy of the incoming flow is transferred to the vortex flows formed by the slip due to the velocity difference to the region with flow separation.

When the swirling flow is formed, the rotation direction of this flow depends on the direction of the tangential inlet, and this rotation direction is fixed and cannot be changed. Therefore, unidirectional swirling flow is a constant and unchangeable characteristic in the operation of mechanical systems.

It is possible to benefit from designs that produce swirling flow in flow control apart from injector application. In this type of use, there is a single-phase fluid. For example, in the aerodynamic flow control, there is air as a single-phase fluid, and the existed air in the middle of the air cone generated by the swirling flow is mixed with the swirling flow, forming a tornado-like structure. Fluid can be sent tangentially from single or multiple inlets to swirling flow generating section regardless of the phases involved. The fluids sent tangentially to the devices operating with the aforementioned principle are that, depending on the inlet positioning, they enter the device with either a clockwise or counter-clockwise rotation and leave the device in the same rotation direction.

The patent file “TR201723597” in the state of the art, titled “Wing Profile with Integrated Vortex Producer Flap Mechanism that Opens and Closes by itself according to Flow Rate” has been examined. The abstract part of the invention that is the subject of the application reads: “The invention includes the leading edge of an airfoil, which is the part where the fluid first encounters at the front end, the trailing edge where the fluid entering from the leading edge leaves the airfoil, the chord, the main part (the part between the leading edge and the trailing edge) and the upper surface and the lower surface on this main part; the airfoil structures such as that are used on aircrafts, propellers, pumps, fans, micro and unmanned aerial vehicles and wind turbine systems seen in aviation and energy sector contains tabs and swirl/vortex-generators that are placed behind the main part of the airfoil structures on these configurations, and the angle of the flap changes as the force due to flow inertia changes with the flow velocity. As a result of this change being transferred to the swirl/vortex-generators with the help of a flap actuator, transmission element and swirl/vortex-generator actuator, in case the velocity of the flow decreases, the swirl generators are pushed by means of actuator springs to open the covers and swirl/vortex generators to re-emerge from the slot in the airfoil main part to the upper surface of the wing. It is the airfoil profile that ensures the desired aerodynamic performance and efficiency to be obtained based on the flow velocity, by enabling the flap to gain an angle by moving the flap actuator whereas the transmission element connected to the swirl/vortex-generators actuators via a shaft moves upwards. System includes the swirl/vortex-generators and their parts, the slot and the cover, behind the main part of the wing profile, the flap actuator, which are the connecting elements that enable the movement between the flap and the swirl/vortex-generators, the transmission element, the swirl generator actuator, the shafts and the actuator spring.”

Patent document no “US20170016462A1” in the state of the art is reviewed. The invention that is the subject of the application discloses a method of controlling a fluid flow using momentum and/or vorticity injections. Actively controlling an actuator allows for direct, precise, and independent control of the momentum and swirl entering into the fluid system. The perturbations are added to the flow field in a systematic mater providing tunable control input, thereby modifying behaviour thereof in a predictable manner to improve the flow characteristics.

Patent document no “US2016318602A1” in the state of the art is reviewed. The invention that is the subject of the application discloses an aerodynamic surface defining an outer mould line over which a fluid is to flow in a downstream direction, the outer mould line defining a smooth contour that is interrupted by step down region that is inset relative to the smooth contour defined by the outer mould line upstream thereof and the aerodynamic surface assembly facilitating the control of flow over the aerodynamic surface comprising a fluid actuator and a projection extending from the outer mould line of the aerodynamic surface in the upstream direction at the vent.

Patent document no “U.S. Pat. No. 7,967,258B2” in the state of the art is reviewed. The invention that is the subject of the application discloses a method for actively manipulating the fluid flow over a surface of the system, which comprises synthetic pulsators housed in a pulsed-jet ambient pressure chamber capable of operating to manipulate the primary fluid flow and incorporating synthetic jet actuators that produce an oscillating flow.

### The Aim of the Invention

The most important aim of the invention is to continuously change the direction of rotation of the vortex flow periodically without using moving parts.

Another aim of the invention is to provide a more homogeneous mixing by periodically changing the rotation direction.

Another aim of the invention is to distribute the mixture, which is always in a single rotation direction, to both rotation directions, since the rotation direction can be changed continuously and periodically despite the fact that it produces a swirling flow continuously, and thereby eliminate the negative effects that these rotation movements may create on the force balance of the system.

Another aim of the invention is to increase the atomisation performance by increasing the fluid instability that causes atomisation due to inertial forces during intermittent and periodically rotation direction changes.

Another aim of the invention is to increase the mixing performance or flow control efficiency as desired as a result of fluid instability between flows with different rotation directions due to the constant change of rotation direction, and vortices that will occur due to Kelvin Helmholtz instability.

Another aim of the invention is to homogenise the flow control effect spanwise by changing the flow direction, unlike the old-style flow control devices in the state of the art that can rotate in one direction. The invention increases the effect and stability of the flow control system by ensuring that the fluid flowing over the wing is homogeneously distributed across the wing width by changing the rotation direction continuously and periodically.

Another aim of the invention is to prevent and/or delay flow separations, thus providing flow with the desired character.

### DESCRIPTION OF DRAWINGS

FIGURE-1; The drawing that gives the image of the product that is the subject of the invention.

FIGURE-2; The drawing that gives the side view and the view of the angle region of the product that is the subject of the invention.

FIGURE-3; The drawing that gives a detailed view of the product that is the subject of the invention.

FIGURE-4; The drawing that gives the image of the diverter surface of the product that is the subject of the invention.

FIGURE-5; The drawing that gives the front detail of the diverter surface of the product that is the subject of the invention.

FIGURE-6; The drawing that gives the appearance of the elliptical shape of the rotation channels of the product that is the subject of the invention.

FIGURE-7; The drawing that gives the top view of the shape of the rotation channels of the product that is the subject of the invention.

FIGURE-8; The drawing that gives the image of the islet structures of the product that is the subject of the invention.

FIGURE-9; The drawing that gives a representative image of the flow direction in the product that is the subject of the invention.

### REFERENCE NUMBERS

100. Swirling Flow Generating Device That Can Change the Rotation Direction Periodically
110. Inlet End
112. Outlet End
120. Fluidic Oscillator
121. Fluidic Oscillator Left Feedback Channel
122. Fluidic Oscillator Main Oscillation Channel
123. Fluidic Oscillator Right Feedback Channel
124. Separator
125. Intermittent Flow Left Distribution Channel
126. Intermittent Flow Right Distribution Channel
130. Chamber
131. Diverter Surface
150. Left Islet
160. Right Islet
F. Flow Direction
A. Angle DESCRIPTION OF THE INVENTION

The invention is a swirling flow generating device (100) capable of periodically changing the integral rotation direction, comprising inlet end (110) that allows the fluid to enter through a single channel, fluidic oscillator (120) that comprises fluidic oscillator left feedback channel (121), fluidic oscillator main oscillation channel (122), fluidic oscillator right feedback channel (123), separator (124), intermittent flow left distribution channel (125) and intermittent flow right distribution channel (126), left islet (150) and right islet (160) that attach and oscillate the fluid on it, the chamber (130) with a cylindrical surface for the fluid to form swirl motion, the diverter surface (131) that oscillates the fluid within the chamber (130) and the outlet end (112) that allows the fluid to come out of the device as unstable liquid sheets that turn into droplets quickly with the swirling flow.

The fluidic oscillator (120) consists of fluidic oscillator left feedback channel (121), fluidic oscillator main oscillation channel (122), fluidic oscillator right feedback channel (123), separator (124), intermittent flow left distribution channel (125) and intermittent flow right distribution channel (126), left islet (150) and right islet (160) The fluidic oscillator left feedback channel (121), fluidic oscillator main oscillation channel (122) and fluidic oscillator right feedback channel (123) are channels that are interconnected at the entrance of the fluidic oscillator (120). The fluid enters the device (100) that can periodically change the rotation direction from the inlet end (110), and first comes to the fluidic oscillator main oscillation channel (122). The fluidic oscillator left feedback channel (121) and the fluidic oscillator right feedback channel (123) are located on the relative right and left side of the fluidic oscillator main oscillation channel (122). The flow direction (F) of the fluid flowing through the fluidic oscillator left feedback channel (121) and the fluidic oscillator right feedback channel (123) is opposite to each other with the flow direction (F) of the fluid flowing through the fluidic oscillator main oscillation channel (122). The fluid attaches to the left islet (150) or the right islet (160) from the fluidic oscillator main oscillation channel (122), and moves towards one of the intermittent flow left distribution channel (125) or the intermittent flow right distribution channel (126). Fluid that cannot be oscillated to either the intermittent flow left distribution channel (125) or the intermittent flow right distribution channel (126) joins the flow by coming to the entrance of the fluidic oscillator main oscillation channel (122) by means of the fluidic oscillator left feedback channel (121) or the fluidic oscillator right feedback channel (123), and periodically change the flow direction (F) at fluidic oscillator's exit. The amount of fluid passing through the fluidic oscillator left feedback channel (121) or the fluidic oscillator right feedback channel (123) is smaller than the amount of fluid flowing through the fluidic oscillator main oscillation channel (122). Therefore, the fluid coming to the entrance of the fluidic oscillator main oscillation channel (122) by advancing from the fluidic oscillator left feedback channel (121) or the fluidic oscillator right feedback channel (123) can only affect the flow direction (F) without stopping the flow flowing through the fluidic oscillator main oscillation channel (122). With this effect, the fluid can be oscillated to attach to the left islet (150) or the right islet (160) after entering the fluidic oscillator main oscillation channel (122).

The feedback flow in fluidic oscillator left feedback channel (121) comes from the fluid that cannot be diverted to the intermittent flow right distribution channel (126) to leave the fluidic oscillator main oscillation channel (122) and flows toward to the inlet of the fluidic oscillator main oscillation channel (122) that is attached on the left islet (150) pushes the main jet in the fluidic oscillator main oscillation channel (122) thus the flow direction (F) of the main jet is changed by the attachment of the main jet onto the right islet (160). The feedback flow in fluidic oscillator right feedback channel (123), on the other hand, comes from the fluid that cannot be diverted to the intermittent flow right distribution channel (125) to leave the fluidic oscillator main oscillation channel (122) and flows toward to the inlet of the fluidic oscillator main oscillation channel (122) that is attached on the left islet (160) pushes the main jet in the fluidic oscillator main oscillation channel (122) thus the flow direction (F) of the main jet is changed by the attachment of the main jet onto the right islet (150).

Left islet (150) is located between the fluidic oscillator main oscillation channel (122) and the fluidic oscillator left feedback channel (121). Right islet (160) is located between the fluidic oscillator main oscillation channel (122) and the fluidic oscillator right feedback channel (123). Left islet (150) and right islet (160) allow creating the feedback flow that is in the opposite direction of the streamwise flow inside the fluidic oscillator main channel and this feedback flow is necessary for fluidic oscillator to operate in a periodic manner as expected.

The separator (124) is located at the exit of the fluidic oscillator main oscillation channel (122), and forms the intermittent flow left distribution channel (125) and the intermittent flow right distribution channel (126). The separator (124) in the fluidic oscillator (120) ensures that the fluid coming from the fluidic oscillator main oscillation channel (122) moves through the intermittent flow left distribution channel (125) or the intermittent flow right distribution channel (126), depending on the flow direction dictated by the fluidic oscillator output flow. In this way, while the fluid moves through the intermittent flow distribution channel it follows, it cannot enter the other intermittent flow distribution channel. Thus, when the fluid enters the chamber (130), it may have a different rotation direction. The fluidic oscillator (120) is a feedback-type fluidic oscillator; however, other types of fluidic oscillators such jet interaction type (also known as feedback-free fluidic oscillator) fluidic oscillator can also be utilized to perform the same function for swirling flow generating device that can change the rotation direction periodically (100).

The chamber (130) may have, depending on the velocity of the incoming fluid, an oscillator cylindrical or conical surface, where the rotational flow that enables the swirling flow to occur and allows the fluid to reach the outlet end (112). For the device (100) that generates swirling flow, which can periodically change the rotation direction, while other surfaces with various geometrical shapes can also be used the chamber (130) with a cylindrical surface is preferred.

There is a certain angle (A) between the section of the monolithic body containing the inlet end (110) and the fluidic oscillator (120) and the chamber (130) section. This angle (A) may vary between −90° to +90°. By means of this angle (A), the fluidic oscillator (120) has a slope. By means of this slope, the fluid can enter the chamber (130) by reducing the resistance it will encounter while moving through the fluidic oscillator (120). Also, the fluid coming from either the intermittent flow left distribution channel (125) or the intermittent flow right distribution channel (126) is prevented from flowing back into intermittent flow left distribution channel (125) or intermittent flow right distribution channel (126) that does not have flow in it. For example, when the fluid begins to rotate towards the outlet (112), depending on the slope of the angle (A) between the section containing the fluidic oscillator (120) and the chamber (130) section, the fluid coming from the intermittent flow left distribution channel (125) cannot flow back into the intermittent flow right distribution channel (126).

In the version of the swirling flow generating device (100), which can periodically change the rotation direction, shown in Figure-1, Figure-2 and Figure-3, since the value of the angle (A) between the section containing the fluidic oscillator (120) and the chamber (130) section is different from 0°, there is no need for a protruding diverter surface (131) that is aligned between the intermittent flow right distribution channel (126) and the intermittent flow left distribution channel (125) at the end point in the opposite direction of the inlet end (110) within the chamber (130) section, and as a result, the continuity (i.e., no flow back into the inactive intermittent flow distribution channel at that instance) of the intermittent periodic flow can be ensured.

In Figure-4 and Figure-5, in another version of the invention in which the angle (A) between the channel structure (120) and the chamber (130) section is 0°, a protruding diverter surface (131) aligned between the intermittent flow right distribution channel (126) and the intermittent flow left distribution channel (125) is shown at the end point in the opposite direction of the inlet end (110) within the chamber (130) section. By means of the diverter surface (131) advancing in the preferred direction in the intermittent flow right distribution channel (126) and the intermittent flow left distribution channel (125) formed by the separator (124), the fluid is oscillated towards the outlet end (112) by forming swirling in the chamber (130) directly without entering the other channel.

In another version of the invention shown in Figure-6 and Figure-7, the intermittent flow right distribution channel (126) and the intermittent flow left distribution channel (125) provide the entrance of the fluid to the chamber by enclosing the chamber (130) wall in an elliptical manner from the end point in the opposite direction of the inlet end (110).

The fluid, entering the chamber (130) through the one of the intermittent flow distribution channels, encounters the fluid coming from the same channel outlet after 1 turn in the chamber (130) and is necessarily directed towards the outlet end (112) due to the flow entering the chamber (130). Thus, the fluid coming out of one of the intermittent flow distribution channels that provides the flow to the chamber (130) cannot enter the other inactive (i.e., no flow) intermittent flow distribution channel.

Figure-9 (a) and Figure-9 (b) show the advancing of the fluid in the swirling flow generating device (100) that can periodically change the rotation direction. With the flow direction (F) how the direction of the fluid changes periodically is shown. The fluid moves through the swirling flow generating device that can periodically change the rotation direction, as follows:
The fluid entering into the swirling flow generating device (100) that can periodically change the rotation direction over the inlet end (110),
The fluid entering into the fluidic oscillator main oscillation channel (122) located in the fluidic oscillator (120),
The left islet (150) in the channel structure (120) of the fluid attaching to the surface on the side of the fluidic oscillator main oscillation channel (122) and advancing along this surface,
The fluid heading towards the right intermittent flow distribution channel (126) from the outlet of the fluidic oscillator main oscillation channel (122) after advancing on the surface of the left islet (150),
The fluid entering the chamber (130) by advancing in the intermittent flow right distribution channel (126),
The fluid entering the chamber (130) oscillating towards the exit end (112) with clock-wise rotational movement,
The fluid exiting from the outlet end (112) in a way that creates swirling flow,
The portion of the fluid that cannot exit from the outlet of the fluidic oscillator main oscillation channel (122) to the intermittent flow right distribution channel (126) flows back towards the fluidic oscillator left feedback channel (121), after the fluid advanced on the surface of the left islet (150),
The fluid flow generated in the fluidic oscillator left feedback channel (121) flows towards the entrance of the fluidic oscillator main oscillation channel (122) and affects the flow direction (F) of the fluid entering the fluidic oscillator main oscillation channel (122) thus changing the flow direction at the outlet of the fluidic oscillator (120),
With the effect of the fluid coming from the fluidic left feedback channel (121), the fluid entering the fluidic oscillator main oscillation channel (122) being pushed onto the right islet (160),
The fluid adhering to the surface of the left islet (160) in the channel structure (120) remaining on the side of the fluidic oscillator main oscillation channel (122) and advancing along this surface,
The fluid oscillating towards the left intermittent flow distribution channel (125) from the outlet of the fluidic oscillator main oscillation channel (122) after advancing on the surface of the right islet (160),
The fluid entering the chamber (130) by advancing in the intermittent flow left distribution channel (125),
The fluid entering the chamber (130) oscillating towards the exit end (112) with counter clock-wise rotational movement,
The fluid exiting from the outlet end (112) in a way that creates swirling flow,
The portion of the fluid that cannot exit from the outlet of the fluidic oscillator main oscillation channel (122) to the intermittent left right distribution channel (125) flows towards the fluidic oscillator right feedback channel (123), after the fluid advanced on the surface of the right islet (160),
The fluid flow generated in the fluidic oscillator right feedback channel (123) flows back towards the entrance of the fluidic oscillator main oscillation channel (122) and affects the flow direction (F) of the fluid entering the fluidic oscillator main oscillation channel (122) thus changing the flow direction at the outlet of the fluidic oscillator (120). This periodic process continues as long as the fluid is supplied to the fluidic oscillator (120).

1. Swirling flow generating device (100) that can change the rotation direction periodically, comprising:
an inlet end (110), where the fluid enters through the connection path,
a fluid entering the device through the inlet end (110) is transferred to the fluidic oscillator (120) with the separator (124) added to the outlet of the fluidic oscillator, separator (124) directs the output jet of the fluidic oscillator (120) to the intermittent flow left distribution channel (125) or intermittent flow right distribution channel (126) depending on the phase of the period, and the fluid advances to the chamber (130) in a periodical manner thus swirling flow generating device (100) that can periodically change the flow direction can operate,
a chamber (130) with a cylindrical wall structure as monoblock with the fluidic oscillator (120), which is positioned to make a certain angle (A) with the fluidic oscillator (120) and allowing the fluid coming from the one of the intermittent flow distribution channels to form swirling flow depending on the velocity of the fluid coming out of the fluidic oscillator (120); and
a protruding diverter surface (131) located at the end of the chamber (130) wall in the opposite direction of the inlet end (110) and prevents the fluid from going to the other channel during the swirling flow formation from the channel from which it comes, thereby ensures that it is directed towards the outlet without back flow to the other channel
an outlet end (112), mounting under the chamber (130), through which the fluid exits.

2. Swirling flow generating device (100) that can change the rotation direction periodically according to claim 1, wherein the angle (A) at which the monoblock fluidic oscillator (120) and the chamber (130) are positioned is between −90° and +90°.

3. (canceled)

4. Swirl flow generating device (100) that can change the rotation direction periodically according to claim 1, comprising the intermittent flow right distribution channel (126) and the intermittent flow left distribution channel (125) that enter the chamber (130) by following elliptical extension of the intermittent flow distribution channels from the end point.

5. Swirling flow generating device (100) that can change the rotation direction periodically according to claim 1, comprising the chamber (130) that has constant or changing cross-section towards the outlet end (112).

6. Swirling flow generating device (100) that can change the rotation direction periodically according to claim 1, comprising the process steps of:
The fluid entering into the swirling flow generating device (100) that can periodically change the rotation direction over the inlet end (110),
The fluid entering into the fluidic oscillator main oscillation channel (122) located in the fluidic oscillator (120),
The left islet (150) in the channel structure (120) of the fluid attaching to the surface on the side of the fluidic oscillator main oscillation channel (122) and advancing along this surface,
The fluid heading towards the right intermittent flow distribution channel (126) from the outlet of the fluidic oscillator main oscillation channel (122) after advancing on the surface of the left islet (150),
The fluid entering the chamber (130) by advancing in the intermittent flow right distribution channel (126),
The fluid entering the chamber (130) oscillating towards the exit end (112) with clock-wise rotational movement,
The fluid exiting from the outlet end (112) in a way that creates swirling flow,
The portion of the fluid that cannot exit from the outlet of the fluidic oscillator main oscillation channel (122) to the intermittent flow right distribution channel (126) flows back towards the fluidic oscillator left feedback channel (121), after the fluid advanced on the surface of the left islet (150),
The fluid flow generated in the fluidic oscillator left feedback channel (121) flows towards the entrance of the fluidic oscillator main oscillation channel (122) and affects the flow direction (F) of the fluid entering the fluidic oscillator main oscillation channel (122) thus changing the flow direction at the outlet of the fluidic oscillator (120),
With the effect of the fluid coming from the fluidic left feedback channel (121), the fluid entering the fluidic oscillator main oscillation channel (122) being pushed onto the right islet (160),
The fluid attaching to the surface of the left islet (160) in the channel structure (120) remaining on the side of the fluidic oscillator main oscillation channel (122) and advancing along this surface,
The fluid oscillating towards the left intermittent flow distribution channel (125) from the outlet of the fluidic oscillator main oscillation channel (122) after advancing on the surface of the right islet (160),
The fluid entering the chamber (130) by advancing in the intermittent flow left distribution channel (125),
The fluid entering the chamber (130) oscillating towards the exit end (112) with counter clock-wise rotational movement,
The fluid exiting from the outlet end (112) in a way that creates swirling flow,
The portion of the fluid that cannot exit from the outlet of the fluidic oscillator main oscillation channel (122) to the intermittent left right distribution channel (125) flows towards the fluidic oscillator right feedback channel (123), after the fluid advanced on the surface of the right islet (160),
The fluid flow generated in the fluidic oscillator right feedback channel (123) flows back towards the entrance of the fluidic oscillator main oscillation channel (122) and affects the flow direction (F) of the fluid entering the fluidic oscillator main oscillation channel (122) thus changing the flow direction at the outlet of the fluidic oscillator (120).
